(19) United States
(12) Patent Application Publication
(10) Pub. No.: US 2006/0250197 A1
(43) Pub. Date: Nov. 9, 2006

(54) Low loss high reliability RF switch and redundancy protection

(76) Inventor: Branislav Petrovic, La Jolla, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/418,645

(22) Filed: May 5, 2006

Related U.S. Application Data
(60) Provisional application No. 60/678,186, filed on May 6, 2005.

(51) Int. Cl. H01P 1/10

(52) U.S. Cl. 333/101; 333/117

(57) ABSTRACT

In many network applications, high reliability is a requirement. One way to achieve this high reliability is to offer a switching device that can switch a malfunctioning piece of equipment out of the network while also switching in a “new” operational piece of equipment into the network to take the place of the original malfunctioning piece of equipment. However, in order to achieve high reliability networks, the switching devices must also be highly reliable. This disclosure describes a new switching device and method that are more reliable when the time comes to swap malfunctioning equipment for operational equipment. The disclosed switching device and method are also protected from various surges experienced in the network.

### CLAIM FOR PRIORITY

This application claims priority to and incorporates by reference provisional application 60/678,186 filed on May 6, 2005.

### BACKGROUND OF THE INVENTION

1. Field of the Invention

This invention relates to a method and apparatus for switching and routing of RF signals with improved reliability and increased failure resistance, particularly against the electrical surge and Electro-Static Discharge (ESD) induced failures, and more specifically for RF switching of relatively low power signals in redundant applications, such as in Cable TV (CATV) transmission, with emphasis on Edge-QAM (Edge-Quadrature Amplitude Modulation or EQAM) installations, where high service availability is required.

2. Background of the Related Art

Most redundancy solutions rely on some type of switching schemes, where a back-up unit is switched-in, replacing the failed device which is switched out. Since the whole protection scheme relies on the ability of a switch to perform its function, clearly the reliability of this redundancy switch is essential—it must be functional and performing much more reliably than the system it is protecting.

In order to achieve high system availability, the redundancy RF switch, in addition to being able to withstand all normal operating conditions without degradation, should also be able to withstand abnormal conditions, without adverse effects on the life time. Electrical over-stress (EOS) is one of the more important abnormal conditions, including mainly Electro-Static Discharge (ESD) and electrical surges (which are mainly power-supply transients, and/or transients induced by lightning). The adverse effects of exposure to such stress conditions must be minimized in order to achieve satisfactory redundancy protection provided by the RF switches.

Use of semiconductor devices for RF switching applications is typically avoided in applications where redundancy function is required and increased exposure to EOS is expected. The devices that are generally avoided include active GaAs IC and Silicon-On-Insulator IC switches, RF CMOS switches, etc. The exclusion is not limited to switch elements only—excluded are also most active devices, such as RF MMICs, transistors, etc. One such application is in Cable TV (CATV) transmission. This is particularly true in emerging edge-of-the plant installations, such as hubs or nodes, where Edge-QAM devices are being deployed at an increasing rate. In these installations, the outdoors cable network is exposed to electrical discharges caused by lightning, and inadvertently serves as a conduit of this energy back into the sensitive electronic equipment. In addition, the path through the mains is always an opportunity for surge to strike. In these applications, the electromechanical relay is a preferred choice over any active semiconductor device. Undoubtedly it's due to better EOS withstanding capability of relays, despite the well-known relay's Mean Time Between Failures (MTBF) inferiority compared to solid state devices. Common belief is that field failures, particularly in applications involving outdoors cabling, are often more attributable to EOS exposure than to MTBF causes and therefore the EOS withstanding capability advantage of the relay may out-weight its MTBF shortcomings.

Relays' failure mechanisms, including both mechanical and electrical modes have been studied extensively in the industry. The findings are that the mechanical relay failures are rare in comparison with electrical, and that mechanical functionality typically outlasts relay's electrical. Evident from specification data sheets of many relays, contact forces are very durable and remain strong after millions of toggling cycles. Of more interest for considerations in the present invention is the static case, when contacts normally don't toggle at all. Favorably, in that case the mechanical durability should be even better, because material fatigue tends to be lower in static conditions.

Concerning electrical causes, the failure mechanisms in relays include contact-related and coil (actuator) related failures, with contact failures being dominant by far. In general switching applications, where circuit currents and voltages are present during switching, most relay failures are associated with electrical fatigue of the contacts, caused by high number of repetitive switching of the load current (i.e. high switching duty-cycle) performed by a relay in its course of operation. Typical failure mechanism is erosion of the contacts due to material migration from one side of the contact to another, caused by electrical arcing during switching of currents and voltages. The erosion causes increased contact resistance and leads to ultimate relay failure after certain number of switching cycles.

In redundancy applications this type of failure mode is not expected, because the contacts normally do not toggle, but rather stay static in one position most of the operational life. Understandably, in a well designed system the back-up unit should switch-in very rarely, only upon a failure of the main unit. In addition, the RF redundancy relays in many cases do not switch any significant currents or voltages that may cause arcing. This is particularly true in low power RF applications, such as in CATV, where power levels are in the order of few tens of milliwatts only. On the other hand, in order to occur, electrical arcing doesn't necessarily need the presence of normal circuit currents or voltages—it can be induced by ESD or surge transients. This can happen to open-contacts, when high transient voltage breaks through the dielectric (usually air with RF relays) in the gap between the contacts and arcs. This is a type of event that may occur in redundancy applications, and should be included in design considerations.

Another common failure mode is welding of the contacts due to high temperatures generated by I²R heat dissipation, if excessive currents are allowed to flow through the contact junction. This type of relay failure mode is the most likely one to occur in RF redundancy switches, particularly in Edge-QAM applications, where excessive surge currents are likely to occasionally or frequently strike. Unless effective measures are taken to reduce or prevent flow of these currents through the switch, this may well be the dominant failure mode of RF switch redundancy protection gear itself. However, even this failure mode should be very rare, since the relay's contact exposure to excessive currents is not much worse than that of the center conductors of numerous coaxial cables in the plant, mated connectors of which normally experience and successfully survive similar stress conditions.

Relay contacts may also be vulnerable to failures induced by atmospheric and chemical exposure (oxidation, corrosion, chemical reaction, electro-voltaic effects, particle contamination, etc.). These factors may cause contact degradation over time, particularly in static (no toggling) conditions of the contacts. This is because the toggling helps remove some of the unwanted deposits, oxidation, contaminants, etc. from the contacts via micro-sparking usually occurring during switching—this self-cleaning mechanism lacks in the static case. To eliminate or reduce the atmospheric effects, RF relays are made almost exclusively with gold plated contacts, which have the best anti-corrosive properties and substantial immunity to this type of degradation. Generally, this type of potential failure mode should not pose a long-term reliability risk.

While relay is one of the most robust devices available for switching functions, it does nonetheless have vulnerabilities, the substantial adverse impact of which in the circuit topologies of the prior art will become clearer after examination of those circuits.

In FIG. 1 a classic switching solution of the prior art is shown. The switch 10 passes one of the inputs (15 or 16) to the output 5, according to the selected position of the contact wiper 11. While switch 10 can be of any RF type, it is usually realized via a relay, for the reasons explained earlier. This configuration is clearly very simple and has very low insertion loss (IL) of around 0.2 dB (readily available with commercially available RF relays). However, since contact 11 is in the direct signal path, any abnormal surge current accompanying the signal will also flow through the same contacts and may likely cause contact degradation. The surge current can come both from input 15 and back from output 5, aggravating the risk. With repeated surge hits, cumulative and accelerated rise of the resistance over time may occur due to recurring I²R heat dissipation events, leading to deteoriation and ultimate contact failure. This vulnerability severely limits the usability of the circuit of FIG. 1, and despite of all its other advantages, the CATV transmission community has walked away from this type of redundancy switch solution.

To resolve the above problem, i.e. to avoid the passage of the main signal through the RF switch with the intention of preventing the accompanying surge currents from flowing through the switch, the prior art resorted to the circuit of FIG. 2. While it appears that with this circuit the objective of diverting the surge energy away from the RF switch is successfully accomplished, unfortunately in reality it is not the case. More importantly, the circuit of FIG. 2 introduced an even bigger problem, by way of an excessive insertion loss, thus creating a major application issue, discussed in more details shortly. To gain better insight into these matters, it is useful to first briefly review the basic characteristics of the transient disturbances, which play a major role in many of the related considerations.

In CATV, telecommunications and other related industries, for test and evaluation purposes the model of a surge waveform and other characteristics based on ANSI SCTE 81 2003 standard are used. It characterizes a typical electrical disturbance caused by lightning discharge. It's time domain waveform (open circuit voltage) is shown in FIG. 14a. As seen from the plot, the time scale of surge transient events caused by lightning strikes is in the order of microseconds. The transients typically rise, reach the peak and decay in the time frame between a few microseconds and a few tens of microseconds. The spectrum of this waveform has been computed and plotted (solid line) in FIG. 14b (dB/Log plot) and in a FIG. 14c (linear plot). The plots reveal that the peak energy of this type of transients occurs at lower frequencies, with bulk of it below 10 kHz, which is clearly very important to keep in mind while making considerations for surge protection. The peak level (normalized to 1 in the plot) can reach several thousand Volts and hundreds of Amps. The released energy levels are high, on the order of few Joules, and occasionally can be much higher.

Another type of surge waveform known as a “Ring Surge”, also specified in ANSI SCTE 81 2003 standard is often used to model the lightning surge coming from the mains and is somewhat faster. Its plot in FIG. 15a shows a decaying oscillatory waveform with frequency close to 100 kHz. The computed spectrum plot (FIG. 15b, solid line) confirms that the power is concentrated closely around the 100 kHz region.

The surge energy may enter the system via AC power lines, carried to the circuitry through device's power supply system, or the lightning surge can come via outdoors cables. The surge direction from the latter direction presents higher risk, because it is harder to effectively protect high frequency RF circuits because of lack of effective protection devices that do not interfere with RF operation. Obviously, the direction from the outdoors cable plant is typically more important in surge protection and redundancy related considerations for those parts of the system interfacing more closely or directly with that plant. Power supply is usually much better protected, since unlike in RF, the surge protection devices having high capacitances, which are readily available, can readily be used without much concerns of adversely loading or affecting the signal lines.

Transients generated in AC power transmission system due to activity in the network (such as switching of heavy loads, industrial motors, machinery, etc.) tend to be slower, in the order of tens or hundreds of microseconds, having the dominant energy in the kHz range.

In contrast to lightning and power disturbances, the ESD events are much faster—they occur in the nanosecond scale, having the energy spread from a few MHz through to a few hundred MHz, as indicated by fast edges and short time duration of an ESD waveform shown in FIG. 16a, which is the ESD Human-Body Model (HBM) of IEC1000-4-2_{—}1995 standard as well as with the spectrum obtained by Fourier transform of the same waveform plotted in FIG. 16b. While being much faster and therefore harder to deal with, and having equally high or even higher voltages than their surge counterparts (some ESD models call for voltages of tens of kV), the ESD transients are much less energetic than the lightning surges—lower by one or two orders of magnitude, with energy levels typically much below a tenth of a Joule. The reason for lower levels is due to 2-3 orders of magnitude shorter ESD durations. Lower energy levels enable the use of numerous ESD protection devices with sufficiently small capacitances to be effectively used for protection of RF lines, without adversely loading and degrading of RF lines.

The effects the above disturbances and the adverse impact on the prior art circuit of FIG. 2 can now be examined more closely, along with the discussion of its excessive insertion loss issue.

The back-up input (IN2 16) in FIG. 2 is routed through the switch 10, while the main input (IN1 15) is connected to the power combiner 20. The combiner 20 is a well known two-way power combiner (or signal splitter) of the broadband type, extensively used in CATV industry, and well known for its insertion loss penalty of 3.5 dB or more. The combiner utilizes two broadband transformers 21 and 22, constructed with twisted pair windings on ferrite cores. Transformer 22 provides a necessary 2:1 impedance transformation, and transformer 21 is equipped with resistor 23, which accomplishes the isolation between lines 15 and 16. For proper isolation, resistor 23 has the value of twice the line impedance (e.g. for CATV line impedance of Ro=75 Ohm, it is a 150 Ohm resistor). Transformer interconnection in junction 24 completes the circuit. The frequency range attainable with this arrangement is impressively wide, from a low frequency cut-off of about 5 MHz to well over 860 MHz, thus providing the coverage for both upstream and downstream services in CATV.

As said earlier, the excessive insertion loss is a major problem of the prior art solution of FIG. 2. The insertion loss of the combiner 20 is no less than 3.5 dB, due to at least 0.5 dB of circuit losses added to the 3 dB split loss, and that's just the combiner alone, measured directly at its terminals. Embedding it in the application module makes the loss only higher. The additional (excess) loss is primarily due to losses in the additional matching circuits, inescapable when this type of combiner is used in a more complex circuit array, such as the EQAM redundancy switch of the prior art in FIG. 10. It will be shown shortly that the excess loss associated with that circuit easily amounts to 1.5 dB, making the loss of the total solution quickly climb to a figure as high as 5 dB,

The additional matching is necessary because of combiner's relatively poor inherent return loss (RL) characteristics. The reason for poor RL is due to the well known cumulative nature of return loss degradation: a cascade of two similar devices degrades the return loss by 6 dB relative to the single one. That is exactly what the two cascaded transformers 21 and 22 in combiner 20 do—they degrade the return loss thus reducing the available RL budget. While this budget may be sufficient in the case of packaged two-way combiners, allowing them to achieve satisfactory RL without incurring increased IL penalty (which indeed is the case, since two-way combiners are commercially available with a RL around 20 dB, acceptable in most CATV applications, and not more than 3.5 dB IL), this is not true in more complex circuits involving cascade of multiple devices. To maintain acceptable RL, this case requires broadband matching, incurring especially high loss penalty as such. In the case of EQAM redundancy switch of the prior art in FIG. 10, the insertion loss of the necessary matching circuit is in excess of 1 dB. Other losses, such as in PCB traces and connectors add another quarter of a dB or so, resulting in total excess loss of 1.5 dB and a total system loss of 5 dB, as shown in FIG. 10. Another adverse effect of adding matching components is in the potentially reduced reliability of the redundancy device due to increased component count and increased vulnerability to surge-induced failures of these matching components.

This high insertion loss of 5 dB presents serious set-back for this design, particularly in Edge-QAM applications, and presents a high barrier of entry for the prior art design. In a typical EQAM installation in hubs and nodes, the signal level budget is tight, due to combining and splitting of a large number of signal sources and loads. As the capacity of hubs increases through increase of numbers of nodes and channels, the pressure on level availability will only grow, leaving less room for devices that introduce further signal losses.

Continuing the description of FIG. 2, the switch 10 is connected via line 26 to combiner 20. While in the frequency range above 5 MHz, line 26 (and thus the switch 10) is fairly well isolated from the main line 15 by the combiner 20, it is not the true for lower frequencies. As the frequency drops below 5 MHz cut-off, the inductive reactance of the windings of both transformers (21 and 22) becomes progressively smaller, eventually falling-off to zero (at DC). At low frequencies where the surge energy tends to peak, i.e. mainly below 100 kHz, the windings of transformers 21 and 22 offer very low impedances, and can hardly stop or reduce the surge impact. At these low frequencies, the entire combiner 20 can be viewed as one single electrical point, where all lines (15, 26 and 5) short together and connect to switch 10. Thus, a direct path to switch 10 for surge energy both from input 15 and output 5 inadvertently exists, and the whole scheme fails to accomplish the main goal, which is to protect switch 10. Furthermore, the isolation resistor 23, as well as resistor 25, which provides port termination to switch 10, are both likely to fall victims of the surge energy, since they too have no or very little protection. In fact, they may fail before the relay does since typically these resistors are low power surface-mount types, unable to handle any significant power that the surge may deliver. Should the resistors fail, depending on the failure mode and whether both or only one resistor failed and whether they failed short or open, an event like this may easily cause a failure of both the MAIN and BACKUP lines (such as a loss of signal level and degraded return loss), and potentially incapacitate both of them, making matters worse than in the case of no protection. On the other hand, the situation regarding ESD protection is much better since the ESD energy tends to reside at higher frequencies, where combiner 10 provides better isolation (although the isolation resistor 23 may still be vulnerable). This ESD advantage of the circuit does not necessarily justify all the costs incurred by this circuit, since the ESD can be fought effectively in a much easier way.

There is another shortcoming of the FIG. 2 circuit. It's related to the inability of this circuit to isolate the signal coming from the main line in the case of failure of that line. Clearly, the scheme of FIG. 2 is unable to turn the main signal off when it fails, which may be necessary to do in some failure situations; for in instance, if the unit supplying the main signal failed in a mode that generates and injects interfering signals. The circuit of FIG. 2 relies on the ability of the overall system to provide the turn-off function elsewhere. While the turn-on/off function is usually available in the main unit itself (specifically the RF muting), depending on the system design and the type of failure, it is not guarantied that the failed main unit will be able to respond to turn-off or mute commands.

In summary, there are a number of deficiencies associated with the prior art circuits of FIG. 1 and FIG. 2, and there is certainly room in the art for improved solutions. One such solution is the present invention, where an efficient way has been found to reduce or eliminate most or all major weaknesses of the prior art, thus providing a solution for one of the key building blocks necessary in the related applications

### SUMMARY OF THE INVENTION

It is one objective of the method and apparatus of the present invention to provide improved reliability of RF switches by achieving increased withstanding capability against electrical surge and Electrostatic Discharge (ESD).

It is another objective of the present invention to attain increased reliability of RF switches using relays, particularly in redundancy applications.

It is yet another objective of the present invention to achieve the above in combination with achieving very low insertion loss of signals.

It is further an objective of the present invention, in combination with the above, to enable the use of active semiconductor RF switches while attaining sufficient systems EOS resilience.

It is yet another objective of the present invention to enable more flexibility in a system's physical partitioning, allowing for different functions and hardware portions of such system to be mutually combined with greater flexibility.

It is also to be understood that all features noted above need not be included in a given embodiment in order for the embodiment to fall within the scope of the present invention, and that not all deficiencies noted in the prior art need be overcome by a given embodiment in order for it to fall within the scope of the present invention.

### BRIEF DESCRIPTION OF THE DRAWINGS

FIG. 1 is a block diagram of the prior art's classic solution, using Single-Pole Double-Throw (SPDT) RF switch, preferably relay. Key disadvantage of this circuit is in its passing the main signal directly through the contacts, increasing the susceptibility to failures.

FIG. 2 is a block diagram of RF redundancy solution of the prior art, using a power combiner inserted between the output and input ports, with the switch element in the back-up path (IN 2), thus avoiding the switch in the main path (IN 1). Major disadvantage is its high insertion loss of 3.5 dB, which when combined with other circuit losses increases the system loss to as high as 5 dB.

FIG. 3 is a block diagram of the principle embodiment of the present invention, where the switch element is not in direct main signal path (IN 1), but it is rather isolated from the main signal path, i.e. from both the main input port and the output port by the means of a transformer. Key advantage is its extremely low insertion loss, robust surge resilience and low failure rate. The insertion loss of the circuit itself is 0.5 dB, enabling system solutions to achieve 1 dB or less insertion loss.

FIG. 4a is an equivalent block diagram to FIG. 3 of the present invention, shown when IN 1 is selected by the switch, illustrating the principle of operation where the secondary impedance, which is substantially zero due to the short circuit provided by the relay contact, is transformed with a ratio of 1 to 1 to the primary adopting the same near-zero impedance, effectively providing unobstructed full passage of the primary current through the primary circuit. In other words, this figure shows that this circuit in this state provides full passage of IN 1 signal to the output.

FIG. 4b is an equivalent block diagram to the diagram of FIG. 3 of the present invention, shown when IN 2 is selected by the switch, illustrating the principle of operation where the voltage V2 from the secondary side of the transformer gets transferred with a ratio of 1 to 1 onto the primary side as a voltage V1 of equal magnitude, effectively providing full passage of the input signal to the output.

FIG. 5 is a block diagram of another embodiment of the present invention showing the multiplicity of switching elements arranged in parallel configurations.

FIG. 6 is a block diagram of yet another embodiment of the present invention where the transformer orientation is rotated by 90° in respect to the transformer in FIG. 3.

FIG. 7a is a block diagram of still another embodiment of the present invention, with reversed roles of IN 2 pin and the ground pin: pin 16 grounded, and IN 2 connected to pin 33.

FIG. 7b has an additional switch 53 added to the circuit of FIG. 7a to illustrate circuit's ability to engage a third port 5 in the signal switching in addition to two other ports 33 and 15. Since the circuit is reciprocal, any port can be used either as an input or an output, providing greater flexibility.

FIG. 8a is a block diagram of a four-port router, representing a more generic embodiment of the present invention accomplishing a function of a “matrix” switching of 4 ports, i.e. routing or connecting a port to port, while preserving nominal impedance matching in the routed ports. For example, port A is routed to port C when the switches are in the states as shown in this figure. Changing the states of the switches, a different routing path can be chosen. With proper switch positions, any port can be routed to any other, while always preserving impedance matching at the routed ports.

FIG. 8b is a block diagram of a modified present invention circuit of FIG. 8a, where the transformer 49 has been replaced by a pair of coupled L/C resonators 59.

FIG. 8c is a block diagram of a generalized version of the present invention circuit of FIG. 8a, where block 50 represents any coupled circuits or components, such as coupled coils, coupled resonant circuits, coupled transmission lines, directional couplers, 3 dB hybrids, magic tees, etc., including the transformer 49.

FIG. 9a is a block diagram of 6-port router, obtained by arranging two 4-port routers of the present invention circuit of FIG. 8a in an array

FIG. 9b is a block diagram of an N-port router, obtained by arranging multiplicity of 4-port routers of the present invention circuit of FIG. 8a in an array.

FIG. 9c is a block diagram of the present invention's realization of an 8-port router, obtained by utilizing a transformer with multiplicity of windings on the same core (in this case 4).

FIG. 10 is a block diagram of a prior art redundancy solution for Edge-QAM installations, showing a redundancy RF switch bank protecting 12 main lines with one spare backup (protection) line (often referred to as “12+1 redundancy”). The key disadvantage is its high insertion loss of 5 dB, as a consequence of high insertion loss of its main building block, the circuit 20 of FIG. 2.

FIG. 11 is a block diagram of one embodiment of the redundancy solution of the present invention for Edge-QAM installations, showing a redundancy RF switch bank protecting 12 main lines with one spare protection line (“12+1 redundancy”), designed for stand-alone chassis installations. The RF switch circuit of FIG. 3 is utilized as the key element. Key advantage is in the very low insertion loss of the main line of only 1 dB, while the backup line has a loss of 2 dB.

FIG. 12 is a block diagram of another embodiment of the redundancy solution of the present invention for Edge-QAM installations, showing a “12+1 redundancy”, electrically identical to FIG. 11, but designed for internal installation into the chassis with QAM sources, which is its key added advantage by way of eliminating half of the inter-chassis cables. It has the same low insertion loss of 1 dB on the main line and 2 dB on the backup line.

FIG. 13a is a block diagram of yet another embodiment of the redundancy solution of the present invention, this time built-in inside of an individual QAM RF Modulator (QRM). The key added advantage is in reducing the number of RF interconnects by eliminating half of the RF connector pairs, thus reducing the cost as well as improving RF performance and reliability of the entire system. One downside is that interruption of service is necessary should a replacement of QRM units be needed.

FIG. 13b is a block diagram of still another embodiment of the built-in redundancy protection of the present invention, this time embedded inside of the push-pull amplifier 92, taking advantage of its transformer 94 and using it as a part of the RF switch. With this circuit, not only the cables and connectors are saved, but the added benefit is practically lossless redundancy switching. The same downside though of service interruption for repairs is here the case.

FIG. 13c is a block diagram of a modified circuit of FIG. 13b, providing a function of monitoring the output signal in addition to the protection function by sharing the same port 72. This port outputs a small sample of the main (protected) output for monitoring purposes outside the unit, and at the same time serves as the Backup signal input port.

FIG. 13c is a block diagram of a modified circuit of FIG. 13b, providing a function of external powering and controlling the switches 96 and 98.

FIG. 14a is a time-domain waveform of a “Combination Surge Waveform” as defined in ANSI SCTE 81 2003 standard. It models the open-circuit voltage of the surge disturbance.

FIG. 14b plots the spectrum of the surge signal and simulation results of its transmission through the circuit of the present invention of FIG. 3, in the case when the “Combination Surge Waveform” signal is applied to the output pin 5 (OUT) and observed, after passing through the circuit backwards, at the input pin 16 (BACKUP), Solid trace shows the frequency spectrum of the surge source signal (obtained by Fourier transform of FIG. 14a) at pin 5, while the dashed trace shows the residual spectrum of the surge at pin 16. Comparing the two traces reveals the remarkable suppression capability of the present circuit—the surge energy, bulk of which being concentrated below 10 kHz, is suppressed by 40 dB or more, practically eliminating it altogether.

FIG. 14c shows the spectrum of the same signals as FIG. 14b, in linear scale, which even more dramatically illustrates rejection capability of the present circuit of FIG. 3: solid line is the spectrum of the surge signal at pin 5, and dashed line is the spectrum of a portion of that signal appearing at pin 16.

FIG. 14d shows in logarithmic time scale the rejection capability of the present circuit of FIG. 3: solid trace is the Combination Surge Wave voltage, shown again in time domain as applied to pin 5, and dashed line is the generated voltage by a portion of that signal appearing at pin 16; the plot gives more intuitive view of the enormous reduction of the surge energy accomplished by the circuit of FIG. 3.

FIG. 15a is a time-domain voltage waveform of another type of surge wave—a “Ring Surge Waveform”, as defined in the same ANSI SCTE 81 2003 standard.

FIG. 15b is a plot of the spectrum, in linear scale, of the surge signal and simulation results of its transmission through the circuit of the present invention of FIG. 3, but in the case when the “Ring Surge Waveform” signal is applied to the output pin 5 (OUT) and observed, after passing through the circuit backwards, at the input pin 16 (BACKUP); Solid trace shows the frequency spectrum of the surge source signal (obtained by Fourier transform of FIG. 14a) at pin 5, while the dashed trace shows the residual spectrum of the surge at pin 16. In this case, the surge is suppressed by an order of magnitude (˜20 dB), substantially reducing its impact.

FIG. 15c is a log-scale time-domain voltage waveform of the Ring Surge Wave (solid trace) applied to pin 5, and dashed line is a portion of that signal appearing at pin 16; the plot gives more intuitive count of the significant reduction of the surge energy furnished by the circuit of FIG. 3.

FIG. 16a is the ESD waveform of the Human-Body Model (HBM) per IEC1000-4-2_{—}1995 standard.

FIG. 16b is a computed spectrum of ESD waveform of the Human-Body Model (HBM) per IEC1000-4-2_{—}1995 standard.

FIG. 17a is a simulated plot with 75 Ohm system impedance of the amplitude frequency response of the present invention circuit of FIG. 3 (sweep from the output port 5 to the input port 16 (BACKUP) covering the frequency from 10 Hz to 100 MHz). The plot (dB-amplitude/Log-frequency scale) shows a high-pass response of a first order filter equivalent to FIG. 3 circuit, with 20 dB/decade slope below cut-off of about 1 MHz

FIG. 17b is a measured plot (dB-amplitude/Linear-frequency scale) of the amplitude frequency response of the present invention circuit prototype, swept with a network analyzer between the output port 5 and input port 16 from 30 kHz to 10 MHz. The test was done with the circuit built per FIG. 3 with a broad-band transformer widely used in CATV applications, part no. ETC1-1-13 by M/A Corn. The plot shows the amplitude response of the circuit in the vicinity of a 3 dB cut-off frequency close to 1 MHz (measured in 75 Ohm system), in close agreement with the simulation prediction of FIG. 17a

FIG. 18A is an equivalent circuit model of real relay contact, including the parasitic elements of the contact in open position.

FIG. 18B is an equivalent circuit model of real relay contact, including typical parasitic elements of the contact in closed position.

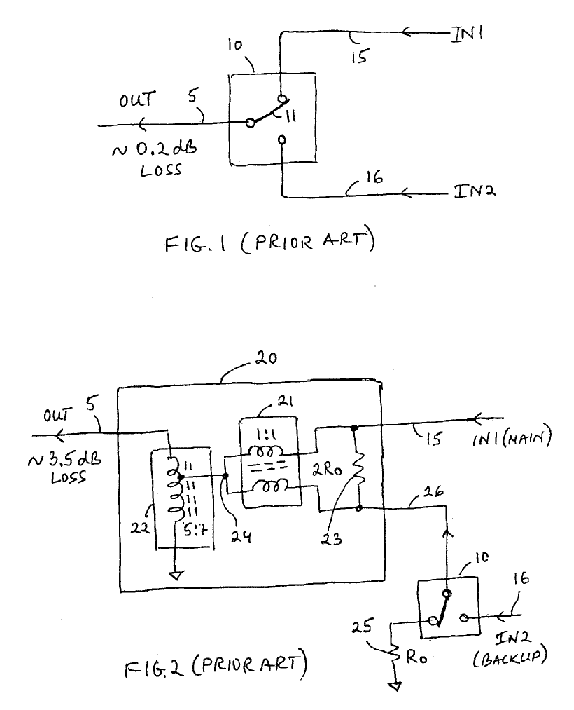

### DETAILED DESCRIPTION OF THE INVENTION

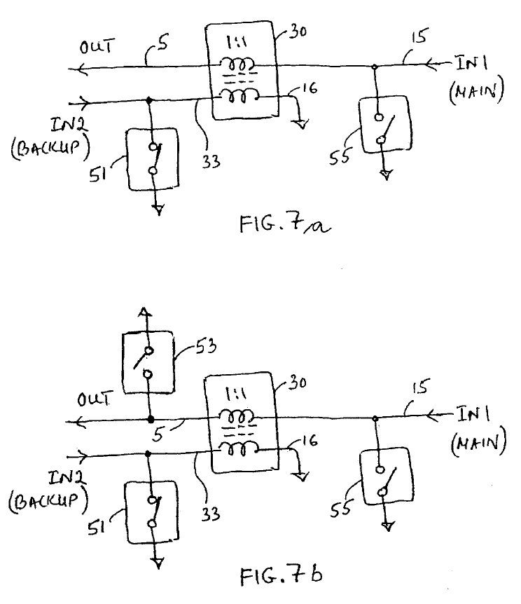

The RF switch solution of the present invention is shown in FIG. 3. This circuit is one of the preferred embodiments of the present invention. The entire circuit is shown inside of block 40 and utilizes a transformer 30 inserted between the output line 5 and input lines 15 and 16, and a switch 10, connected between each of the input lines 15 and 16 and ground. Switch 10 in this figure is shown as an SPDT type, and as such is a special case of a more general case of individual switches separately connected to each line 15 and 16, as disclosed in FIG. 5. The SPDT switch 10 is used with FIG. 3 merely for the more intuitive way it works, facilitating an easier insight into the present invention's operation principle. The present invention takes advantage of the basic transmission property of a transformer, which is that it transfers a signal injected to one pair of terminals through to the other pair of terminals, with the transfer ratio determined by the arrangement of the windings and the number of turns. In the case of transformer 30, the input pair of terminals is a 15 and 16 line pair, and the output pair is lines 5 and 33.

First, we'll say a few words about the transformer 30. While the present invention is not restricted to the use of any particular type of transformer 30, a preferred type for RF applications is one identical to the transformer 21 in FIG. 2. The input/output terminal pairs are connected to the opposite windings rather than to the same windings, unlike the one shown in FIG. 6. Transformer 30 is often referred to as a “transmission line transformer” because it is made by the means of winding a twisted wire pair (which as such forms a transmission line) on a ferrite core. The geometry utilizing transmission line properties of the windings gives this type of transformer an advantage at higher frequencies, helping it achieve very broad bandwidths spanning from a few MHz to well over 1 GHz. Consequential to its twisted pair geometry, the turn ratio of the transformer 30 is naturally 1:1. The insertion loss of this type of transformer is very small, typically less than 0.5 dB. Losses at lower frequencies are dominated by ferrite core losses, while at higher frequencies conductor losses due to skin effect and possibly radiation are more dominant. Examples of commercially available transformers with performance specifications similar to the above are ADTL1-18-75 by Mini-Circuits and ETC1-1-13 by M/A-Com, both parts optimized for 75 Ohm line impedance. It should be understood that the operation of the present invention circuit is not limited to transformers of any specific type or turn ratio—transformers of any type, having any turn ratio can be used. The optimum choice depends on circuit impedance levels at different ports. If circuit impedance levels at different ports are all the same, e.g. 75 Ohms, than a turn ratio of 1:1 is preferred. For the case of different impedances, a turn ratio other than 1:1 should be preferably used, taking advantage of the transformer's impedance transformation properties and thus obtaining impedance matching.

While transformer 30 looks as if “rotated” by 90° in respect to a traditional transformer, it nonetheless operates in a very similar manner. It will transfer the signal applied across terminals 15 and 16 to the terminals 5 and 33 at a ratio of 1:1, i.e. it will “copy” the input signal to the output (preserving the same signal polarity, i.e. 0° phase shift). If instead of applying one signal across two terminals 15 and 16, a ground-referenced signal is applied to one of these two terminals, with the other terminal grounded, transformer 30 will still “copy” this signal from input to output at 1:1 ratio. Reversing the roles of the two input terminals would still result in 1:1 signal transfer, but the signal polarity would be reversed, i.e. it will have 180° phase shift.

This brings us to the heart of the present invention, which, by means provided in the circuit of FIG. 3 enables a way of realizing a reliable and durable switching function (i.e. selecting one or another of the two ports) while at the same time achieving the isolation of one input port from both the other input port and the output port (the switch is reciprocal, so the roles of inputs and outputs can be reversed). The switching method is simple—the switch shorts to ground (i.e. disables) one of the two signals applied to the transformer, so that the transformer passes (enables) the other, un-grounded one, and vice-versa. Furthermore, the switch provides mutual isolation of the two signals, a function which can be advantageously used for insulating the ill effects of a failed source, should it become uncontrollable. Such effects may be unwanted signal injection, line loading, including nonlinear loading causing distortions of wanted signals, etc.

Theoretically, with the method of the present invention, there is no signal loss and the enabled ports are matched to line impedance—the switch simply redirects the signal's entire power in the desired direction. Of course, in reality, a small insertion loss occurs due to circuit losses and mismatches. It is dominated by the transformer loss, while the switch losses (e.g. due to relay's contact resistance) are very low, around 0.1-0.2 dB, but in the present invention circuit it's even lower (since the contact is shunted to ground and so are many of its parasitics) and is practically negligible. Losses due to mismatches are also negligible, thanks to signals' short path through the circuit and lack of components cascades and their adverse effects. In summary, due to their simple construction requiring very few parts, and most importantly only one RF transformer, the circuits of the present invention achieve exceptionally low loss of only 0.5 dB, highly advantageous in many applications, particularly in CATV Edge-QAM systems.

In the configuration shown in FIG. 3, the isolated port is the 1N 2 (BACKUP) port 16, which is isolated from both IN 1 port 15 and output port 5. The switching is accomplished by selectively grounding one of the input terminals 15 or 16 thus enabling signal passage from the other terminal (referenced to ground) to the output, and vice-versa. When wiper 11 of the switch 10 is in the lower position making contact with pin 12 and effectively grounding line 16 as shown in FIG. 3, IN 1 port (constituted of ground-referenced terminal 15) is enabled and the other port (IN 2) is disabled (line 16 shorted to ground). Flipping the wiper 11 to the upper position thus connecting it to pin 14, this time effectively grounding line 15, the conditions are reversed—IN 1 port gets disabled and IN 2 port gets enabled.

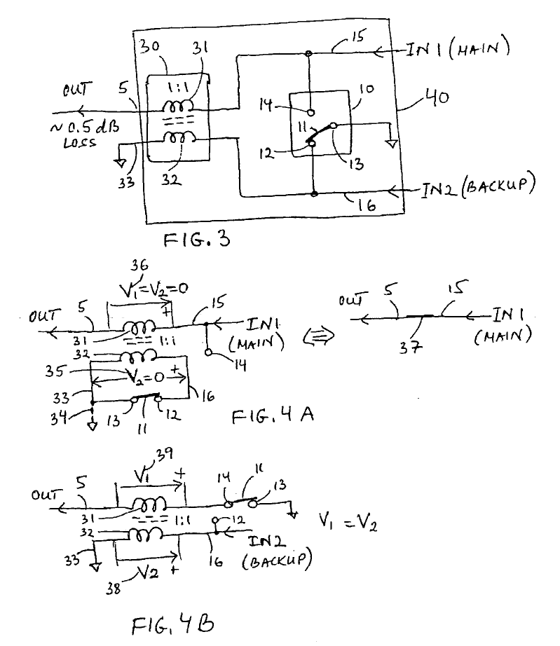

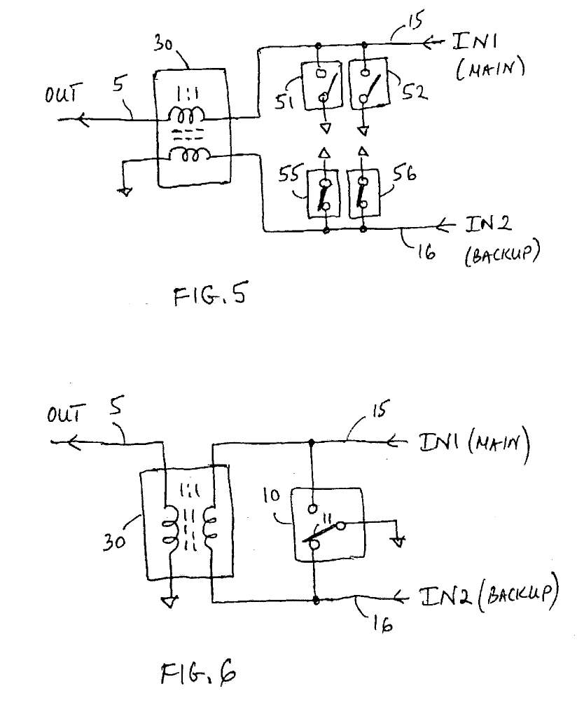

FIGS. 4a and 4b will help illustrate the principle of operation of the present invention circuit of FIG. 3, in each of the two possible switch 10 positions. FIG. 4a shows an equivalent circuit in the case when IN 1 is selected, i.e. when line 16 is grounded. The relay contact wiper 11 short-circuits pins 12 and 13, providing near-zero loading impedance to the secondary winding 32. By transformer action, this impedance is transformed with the ratio of 1 to 1 to the primary winding 31 to the same near-zero impedance, effectively making the primary winding 31 appear as a bridge (short) connection 37. This also means that the primary voltage 36 V1 is zero. That's true because the secondary voltage V2 35 is zero due to a short circuit placed across it by the relay contact wiper 11, and since V1 must equal to V2 due to the 1:1 transformation, it thus follows that V1 must be equal to zero. Either way, it is evident that the transformer provides unobstructed full passage of the primary signal through the primary circuit, i.e. full passage of IN 1 (MAIN) signal to OUT. It's worth mentioning that the polarity (signal phase) of the output signal is equal to that of the input.

FIG. 4b shows the other case of FIG. 3 circuit, which is when IN 2 is selected by the switch. This time, the voltage 38 V2 (input signal) from the secondary side of the transformer gets transferred with the ratio of 1 to 1 into the primary side to voltage 39 V1 of equal magnitude. Since the right-hand side of the secondary winding 31 is effectively grounded (wiper 11 short-circuits pins 14 to pin a ground pin 13), voltage V1 becomes the output voltage, providing the full passage of the input signal IN 2 (BACKUP) to the output, much like in the previous case. The only difference is that now the signal polarity is reversed, i.e. the output is 180° out of phase with respect to the input, which is of no consequence whatsoever.

It should be mentioned that the signal current in both cases must and does flow through the relay contacts. In FIG. 4b this fact may be obvious (the signal current flowing from the output 5 clearly flows through relay contacts 14, 13 and wiper 11). The case in FIG. 4a may not be this obvious. Here, the signal current flows from input terminal 15 to output terminal 5 directly through the primary winding 31, seemingly bypassing relay contacts altogether. However, while flowing through the primary coil 31, this current induces a secondary current of the same magnitude which does flow through relay contacts 13, 12, and wiper 11, connected across the secondary winding 32. Worth noting is that the secondary current would flow in the secondary circuit even if points 13 and 33 were not connected to ground, as long as they are connected to each other (which in reality is accomplished through a piece of ground plane of some length between the two physical terminals 13 and 33). To point out the fact that the ground per se is not essential to the operation, the ground connection of points 13 and 33 is shown in FIG. 4a with a dashed line 34

While it is evident from the short analysis above that the signal does flow through relay contacts in the circuits of the present invention, it is not, however, true for the surge currents when the relay contact is in the position of passing the main signal. The surge currents are prevented of flowing through relay contacts 13, 12, and wiper 11, as elaborated in more details below. Also will be shown that the BACKUP (IN2) port itself is very well isolated and protected from the surge energy coming both from the MAIN and OUT ports and in both positions of the switch 10. This property presents a fundamental value of the present invention, and as such has a broader application potential, beyond the redundancy applications only. The benefit of this inherent protection of the IN2 port can be utilized in many different RF switch applications, particularly those with increased risk of surge exposure, such as antenna Rx/Tx or diversity switches, etc.

The backup circuitry is well protected both in normal mode and backup mode, which will become clearer shortly. While the system is in normal operation, the backup circuitry is well protected and in a healthy condition, always ready to switch-in and provide the protection when called, meeting that way one of the most important redundancy requirements. Even when the system is switched and operates in the backup mode, the backup circuitry is still very well protected, providing more confidence that the system will be available for extended periods of time even in this, emergency state.

As indicated earlier, the present invention's key advantage is in its ability to substantially reject the surge energy, preventing it of reaching and damaging the switching element. This protection capability stems from the circuit's inherent ability to reject low frequency signals. Examining FIGS. 4a and 4b which represent the conditions of FIG. 3 circuit in both possible states of the switch 10 it becomes evident that in each state of the switch 10, IN 2 (BACKUP) port (16) is galvanically insulated from both the IN 1 (MAIN) port (15) and output port OUT (5). That means that DC is blocked from passing from 1N 2 (BACKUP) to both IN 1 (MAIN) and OUT ports. Along with DC, low frequency energy is rejected in a high-pass filter fashion, because of low frequency cut-off of transformer 30. Below cut-off, towards lower frequencies, the transformer windings will have diminishing reactance, thus loosing the ability to generate enough magnetic flux to couple the energy from the primary to the secondary through the transformer core. The system will behave like a high-pass R/L filter of the first order, formed by shunting effect of the transformer inductances and providing a rejection rate of 20 dB/decade below the cut-off. If it's desired to have flat response down to 5 MHz (e.g. less than 0.5 dB of roll-off), the 3 dB cut-off frequency of transformer 30 would need to be designed at 1 MHz. With 20 dB/decade, at the surge energy at 100 kHz the transformer provides the rejection of about 20 dB (e.g. at the Ring Wave frequency). At 10 kHz, the rejection is as high as 40 dB (at the Combination Wave frequency).

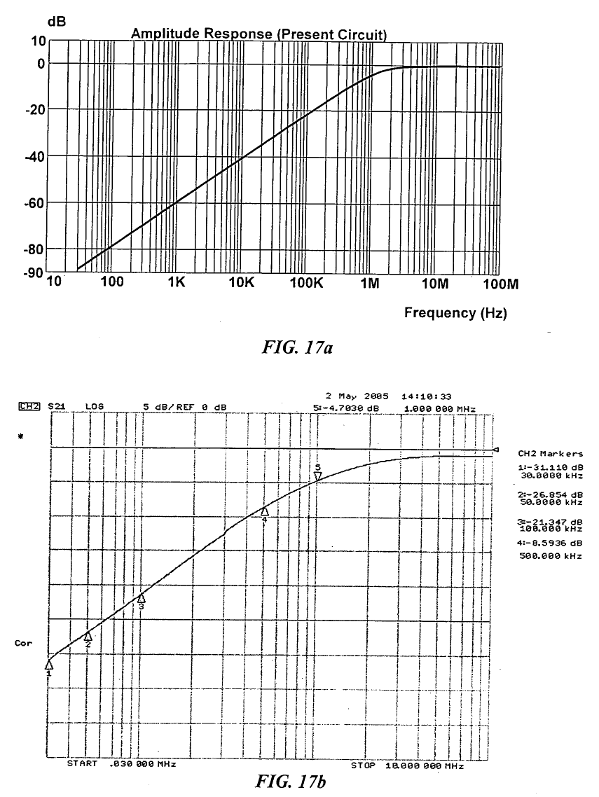

Consistent with the above analysis, FIG. 17a presents a simulated plot of the amplitude frequency response of the present invention circuit of FIG. 3 (sweep from the output port 5 to the input port 15 (BACKUP) covering 10 Hz to 100 MHz frequency range). The plot (dB-amplitude/Log-frequency scale) shows a first order high-pass response of a filter equivalent to FIG. 3 circuit, with a 20 dB/decade slope below 3 dB cut-off of about 1 MHz.

A measurement performed on an actual circuit demonstrates a remarkable agreement with the simulation results. The FIG. 17b is a measured plot (dB-amplitude/Linear-frequency scale) of the amplitude frequency response of the present invention circuit of FIG. 3, swept with a 75 Ohm network analyzer between the output port 5 and input port 16 covering the frequency range of 30 kHz to 10 MHz. The circuit was built per FIG. 3 with a broad-band transformer, part no. ETC1-1-13 by M/A Corn. The plot shows the amplitude response of the circuit in the vicinity of a 3 dB cut-off frequency close to 1 MHz (measured in 50 Ohm system).

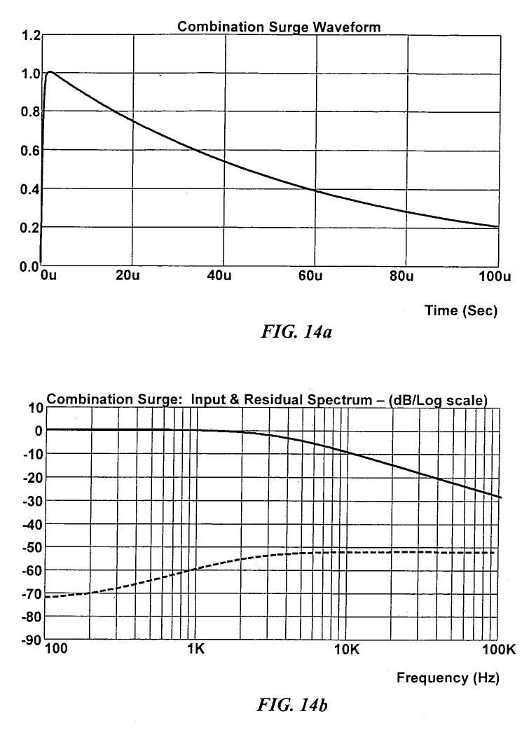

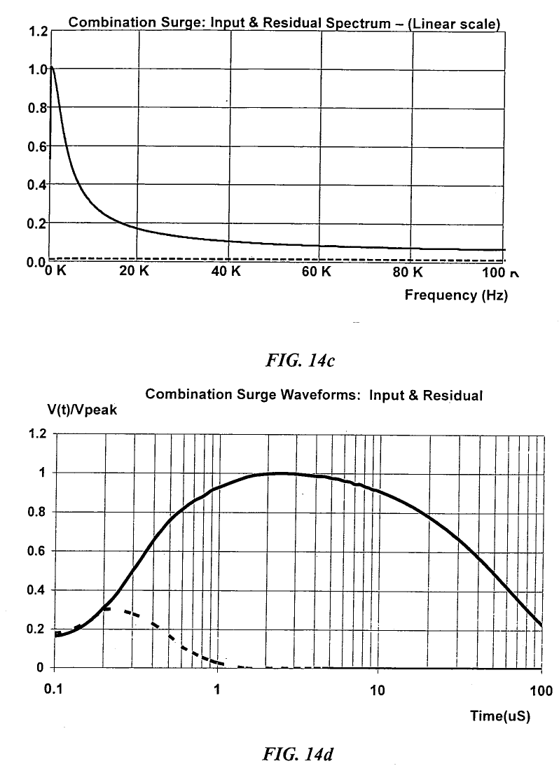

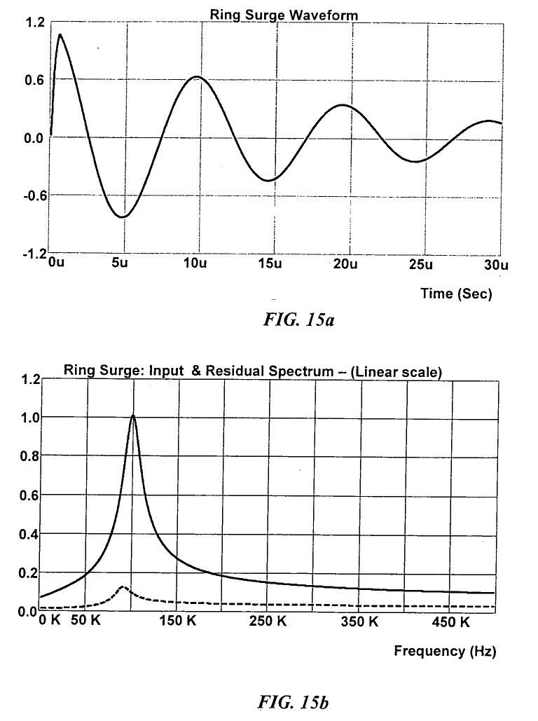

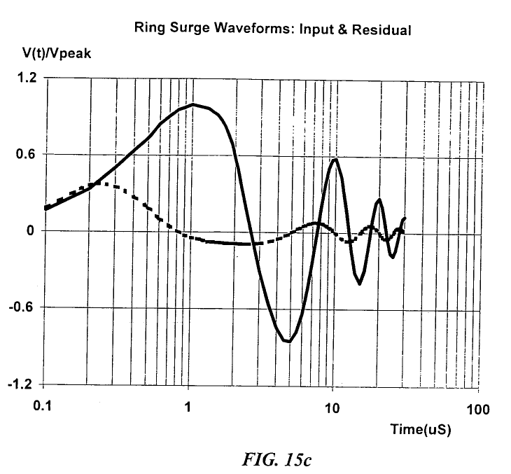

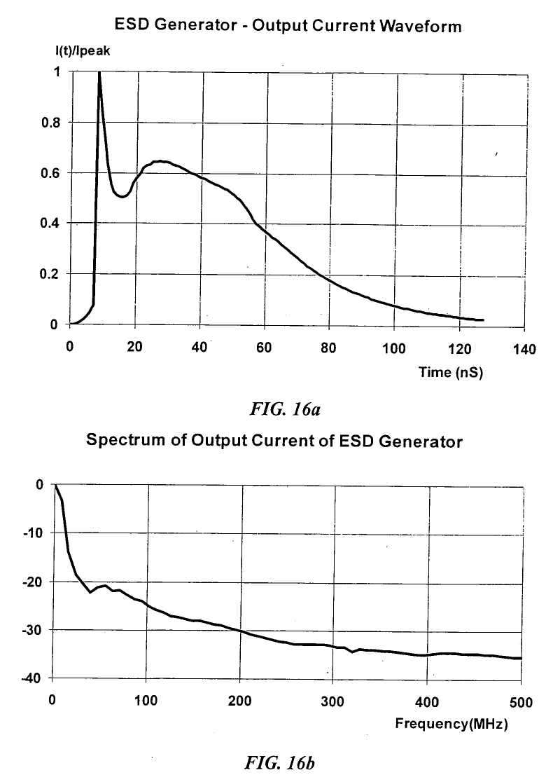

The above measurement increases the confidence that the present invention circuits indeed achieve the stated remarkable surge suppression performance and therefore furnish significant protection to the protected circuitry. A rather dramatic extent of this protection is expressed by a number of simulation curves presented in a series of FIGS. 14 through 16. Each FIGS. 14a, b, c and d, followed by FIGS. 15a, b and c and FIG. 16 a and b (described in more details in the drawings description section) presents a plot in time and frequency domains of different surge and ESD waveforms injected into the present invention circuit of FIG. 3, and simulations of the corresponding rejection of these waves by the circuit. It is evident from these figures that a major portion of the energy is carved-out from the attacking waves, effectively being incapacitated by the present invention circuit.

Furthermore, thanks to favorable topology of the circuits of the present invention, the rejection of the circuit when the switch is in the MAIN position (with wiper 11 in position 12) is even higher than the above simulation predictions. That is because the loading impedance in the MAIN position is a near-short circuit to ground supplied by relay's closed contacts, not the 75 Ohms used in the above measurements and simulations, done for the case when the switch is in BACKUP position. This way, an additional 20 to 30 dB of protection is provided to the BACKUP source in this case. Of course, circuit parasitics (e.g. inter-winding capacitance, ground impedance, etc.) may degrade this rejection to some extent. In the extreme cases, the breakdown voltage of the magnet wire insulation coating (typically shellac) may be exceeded, but that would be the case of high energy, non-survivable surge. The non-linear ferrite core property (i.e. core saturation H-B nonlinear curve discussed below) may help in such cases. It is interesting to note that these very same factors described as the key weakness in the prior art circuit FIG. 2, (namely the transformer low frequency cut-off) turned into the key strengths in the present invention.

Another protective feature of the transformer will help further increase the rejection of the transient energy in the present invention. In question is the non-linearity property of transformer's core ferrite material. It is well known that ferrite materials exhibit strong non-linearity at higher magnetic flux densities (expressed well-known non-linear B-H hysteresis curve) leading to core saturation at very high levels. The saturation of the core presents an inherent protection mechanism which will limit the amount of energy transferable through the transformer. Although somewhat frequency dependent, the saturation is largely a broadband phenomena, which means that protection will be provided at all frequencies, helping suppress some of the higher transient frequencies associated particularly with ESD attacks. However, at increasingly higher frequencies, contribution of the core in signal transfer through the transformer diminishes, since at higher frequencies the transfer is increasingly through transmission line wires direct coupling, less through the core and so diminishes the benefit of the core saturation. The specific design choices, such as the type of the core material, its size, number of turns, etc. affect the actual frequencies where these transitions occur.

Since the surge can hit from both directions (back from OUT 5 or from MAIN 15), it is important to note that the circuit of the present invention provides protection in both of these cases.—it will protect the BACKUP port regardless of the direction. Furthermore, the BACKUP port enjoys one more defense gate, and that's relay's contact, well grounded through its low impedance, thus shunting any residual energy that may have passed through the system. Needless to say, any and all standard protective measures used in fighting the surge and ESD in RF applications, such as ESD diodes, PIN diodes (as protectors), can be applied in combination and as an addition the circuits of present invention, to further reinforce the circuits transient withstanding capability.

It is also worth noting that other devices and components that are installed elsewhere in the circuits or in the system (where the main 15 and output 5 lines of FIG. 3 connect) are also likely to be vulnerable to surge strikes. The protection mechanism of this invention will not provide protection to those—the protection is limited to the circuitry in the secondary side of the transformer 30.

In FIG. 5, a block diagram of another embodiment of the present invention, this time utilizing the multiplicity of switching elements arranged in parallel configurations is shown. Switches 51 and 52, mutually parallel, are connected between the input MAIN line 15 and ground. Likewise, switches 55 and 56 are connected between input BACKUP line and ground. Of course, the number of switches is not limited to two switches per line. Also, the number of paralleled switches on the two lines can be different from each other.

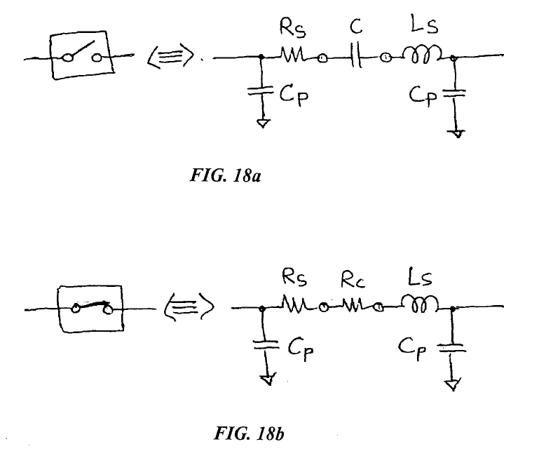

There may be several advantages with this paralleling approach. First, by paralleling switches the reliability improvement of the switch function may be attainable. However, whether the switch reliability is improved would strongly depend upon the predominant failure mode (short or open) of each of the switch types used. This would need to be carefully considered when making choices, since a wrong choice can actually degrade the reliability. Second, the effects of the switch parasitics (e.g. as shown in FIGS. 18a and 18b), i.e. the imperfections of the switch element and their impact on the RF performance (namely the effect on both the insertion loss and isolation) can be improved by paralleling the switches. Third, the switches in the BACKUP line 16 do not necessarily need to be relays—active semiconductor switches may be acceptable at this location, since it is the protected port by the virtue of the present solution. Enabling the use of electronic switches, all of their benefits can be taken advantage of. Last, but not least, paralleling the switches may improve the resilience of the switches to surges failure, since the dissipation of any residual surge energy that makes it to the switch will be shared between the switches, reducing impact on each individual element, thus prolonging the life of all.

Yet another embodiment of the present invention is shown in a block diagram of FIG. 6, where the transformer has an orientation rotated by 90° in respect to the transformer in FIG. 3, which. While the switching function works equally well, it does not protect the BACKUP 16 from a surge coming from MAIN line 15, but it does protect the BACKUP 16 line and MAIN 15 line against a surge coming from OUT 5 direction (DC is isolated as well).

FIG. 7a is a block diagram of still another preferred embodiment of the present invention, with reversed roles of BACKUP (IN 2) pin and ground pin. Here, pin 16 is grounded, and BACKUP is connected to pin 33, resulting in a reversed direction of the BACKUP signal insertion. This arrangement may have some advantages (layout related) regarding isolation between the input ports, and will have some effects on the IL, i.e. will have somewhat different RF transmission properties than the original orientation, which may or may not be advantageous, depending on the specifics.

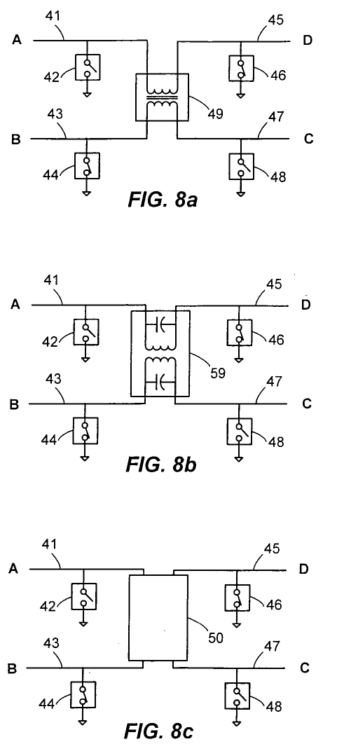

FIG. 7b has an additional switch 53 added to the circuit of FIG. 7a to illustrate circuit's ability to engage a third port 5 in the signal switching in addition to two other ports 33 and 15. Since the circuit is reciprocal, any port can be used either as an input or an output, providing greater flexibility. Both the circuit of FIG. 7a and FIG. 7b are subsets, or special cases of a more generic 4-port router disclosed in FIG. 8a below.

FIG. 8a is a block diagram of a more generic embodiment of the method of the present invention accomplishing a function of the “matrix” switching of 4 ports, i.e. a four-port router. It routes or connects ports, i.e. arbitrarily routes any port to any port, while preserving nominal impedance matching at the routed ports. In the hearth of the structure is the transformer 49 with 4 ports A, B, C and D (41, 43, 47 and 45, respectively). Each port has its own associated switch (42, 44, 48 and 46, respectively). The routing is controlled by the means of the switches in the following way: a port is disabled when its associated switch is closed and the port is enabled when the switch is opened. Ports that have their associated switches opened (i.e. enabled ports) will be mutually interconnected. For example, port A 41 is routed to port 47 C because both of them are enabled since their associated switches 42 and 48 (respectively) are opened, while ports B and D are disabled and therefore not routed, since their respective switches 44 and 46 are closed as shown in FIG. 8a. Changing the states of the switches, a different routing path can be chosen. With proper switch positions, any port can be routed to any other. To maintain impedance matching at the routed ports, only two ports (the ones to be interconnected) should be enabled at a time, while the other two should be disabled. If three switches are closed, the port associated with the forth (the enabled one) will see a short circuit. Likewise, if the three ports are enabled, the fourth one will see an open circuit. If a signal is applied to this fourth port, it will be reflected back in both cases.

While the above described router can be used to route most signals, it is particularly valuable for routing of RF signals. Replacing some of the above switches with direct short circuit connections to ground, and/or removing them, the circuit of FIG. 8a degenerates into some of the circuits disclosed in other figures of the present invention.

The underlying method utilized by the structure of the present invention in FIG. 8a can be better explained by considering the transfer of signals when applied to the structure. The basic behavior is the following: if a port is short-circuited (or open-circuited), a signal entering that port (an incident signal) will be reflected back, or “bounced-off” from that port back in the direction it came from. The phase of the reflected signal will be either in-phase or out-of-phase with the incident signal, depending upon whether the port is open or short-circuited (also depending whether signal's voltage or signal's current is considered—the phase conditions will be complementary to each other in the two cases). The signal will bounce from port to port until it finds a port with an opened switch, loaded into some finite impedance (if the impedance is nominal, equal to the impedance of the signal source, the signal will be completely absorbed by that load; if different, there will be a reflection of the signal, proportional to the amount of impedance mismatch).

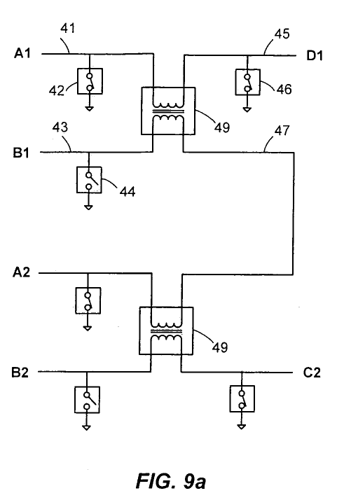

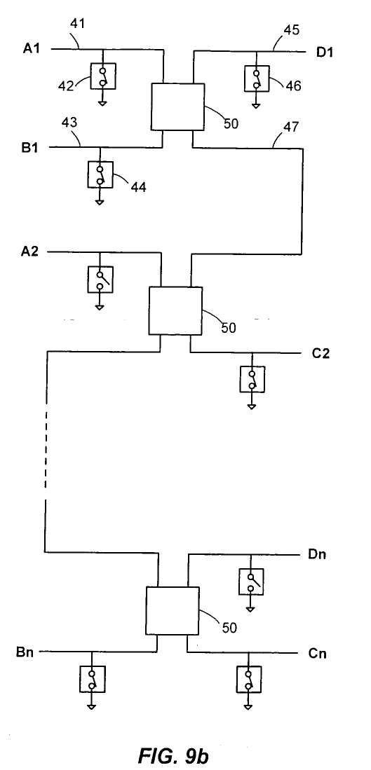

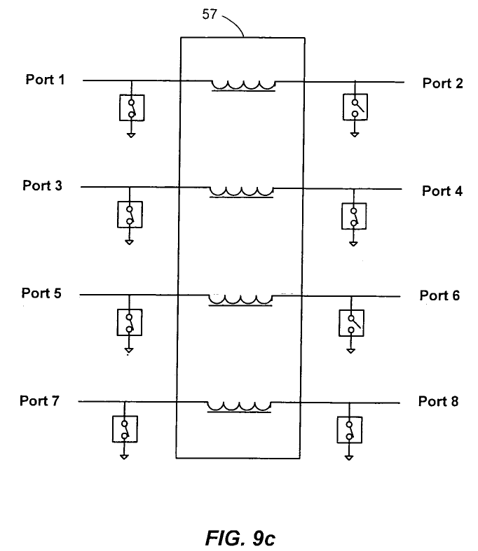

This method can be generalized into a system with an arbitrary number of ports with the ability to perform arbitrary ports routing. It is possible to route the signal through a larger array in much the same way—by bouncing the signal from port to port until it reaches the desired destination. More details are provided in conjunction with FIGS. 9a and b below.

FIG. 8b is a block diagram of a modified present invention circuit of FIG. 8a, where the transformer 49 has been replaced by a pair of coupled L/C resonators 59, illustrating that the method of the present invention is not limited to transformer use only, and that other coupling structures can be used. In general, any coupled circuits or components, such as coupled coils, coupled resonant circuits, coupled transmission lines, etc. can be utilized. FIG. 8c is a block diagram of a generalized version of the present invention circuit of FIG. 8a, where block 50 represents any coupled circuits or components, such as coupled coils, coupled resonant circuits, coupled transmission lines, directional couplers, 3 dB hybrids, magic tees, etc., including the transformer 49. Tight coupling is beneficial, to increase the portion of the signal which is routed.

A large number of ports can be routed by an array of interconnected 4-port routers from FIG. 8c. Enabling or disabling the ports by setting the switches to appropriate states (open or short), an arbitrary path can be established, routing any port to any port, while maintaining the proper matching at the routed ports.

For example, a special case (subset) of such an array can accomplish a function of an “M×N matrix” switching, connecting any one of the M ports to any one of the N ports. This capability is highly desirable in many applications, including redundancy switching.

A block diagram of a 6-port router is shown in FIG. 9a obtained by arranging two 4-port routers of the present invention circuit of FIG. 8a in an array. The two 4-port routers are interconnected by line 47, forming an array with 6 ports. A case of ports B1 and B2 being enabled and inter-coupled is depicted in FIG. 9a. Expanding the method, FIG. 9b is a block diagram of an N-port router, obtained by arranging multiplicity of 4-port routers of the present invention circuit of FIG. 8a in an array. Ports A2 and Dn are shown enabled. The number of available ports is 2(k+1), where k is the number of 4-port routers. One or two inter-connection lines between individual 4-port routers is shown, depending on their location in the array. More interconnects between the routers can be made, in order to provide alternate paths for routing. This redundant routing can be beneficial in increasing the service availability of the present invention switch array.

Another opportunity to utilize the present invention methods is with multi-winding transformers. Transformers having multiplicity of windings, i.e. more than two windings on the same core can be also beneficially used in yet another embodiment of the present invention. FIG. 9c is a block diagram the present invention's realization of an 8-port router, obtained by utilizing a transformer on the same core (in this case 4). Port 2 and port 6 are shown enabled, and therefore inter-coupled. Adding switches to the ports, greater isolation can be obtained and power transfer optimized. Furthermore, the multi-turn based router in this figure can be arranged in an array with other routers of this invention, thus forming an array with even greater port capacity.

A special case of multiple windings is a case of multiple twisted pair windings, where multiplicity of individual twisted pairs are wound on the same core, thus saving separate cores. That way, two individual transformers shown for example in FIG. 9a can be accommodated on one transformer core with separate twisted pair windings for each. The same can be applied to a greater number of transformers. One of the many advantage of this method is to save space and reduce the insertion loss.

In one embodiment of the invention, should an improved inter-port isolation be desired, additional switches can be added to the ports. This can include series switches to further isolate the sources/loads at the ports, or adding more shunt switches in parallel in the ports to reduce the “on” impedance of the switches, when they are in the closed position, thus increasing isolation. It should be understood that like with most circuits in the industry, the performance of the circuits in the present invention can also be improved by standard methods used in the art.

Returning to the discussion of the real components imperfections, the parasitic elements accompanying real relay contacts are shown in FIG. 18A, which shows an equivalent circuit model of the contact in open position, while FIG. 18B shows the equivalent circuit with contacts in closed position. In both cases, the Rs represents a parasitic resistance due to losses in relay's internal transmission line conductors and the coil Ls represents their parasitic inductance. The parasitics of the contact itself are shown as resistance Rc (when closed), and capacitance C (when opened).

These parasitics adversely affect the performance, but more importantly, they play a principal role in degradation of contacts' reliability. By brief qualitative analysis of circuit topology in FIG. 3 it can be easily determined that the closed contact parasitics (Rs, Rc and Ls) degrade both the insertion loss and the isolation between the ports. Less obvious is the way the closed contact position may degrade the contacts' reliability. Contact degradation occurs every time heat is generated when high currents (such as those caused by residual surge energy) flow through the contact's resistance. The heat is released as the I²R ohmic power into the contacts, which may cause micro-melting of contacts' surfaces. The melting causes further increase of the resistance, which in turn further increases the dissipated heat, leading to thermally self-accelerating performance deterioration cycle and eventual contacts' destruction. Regarding the open-contacts case, the parasitic parallel capacitance Cp adversely affects both the return loss (by loading) of the ports, and the inter-port isolation. This capacitance can also increase the risk of arcing across the open contacts when higher surge/ESD voltages are present (higher capacitance potentially means a smaller contact gap, in which case air-dielectric break-down voltage may be lower, making it more vulnerable to discharges). This may be another mechanism of reliability degradation due to contacts' parasitics.

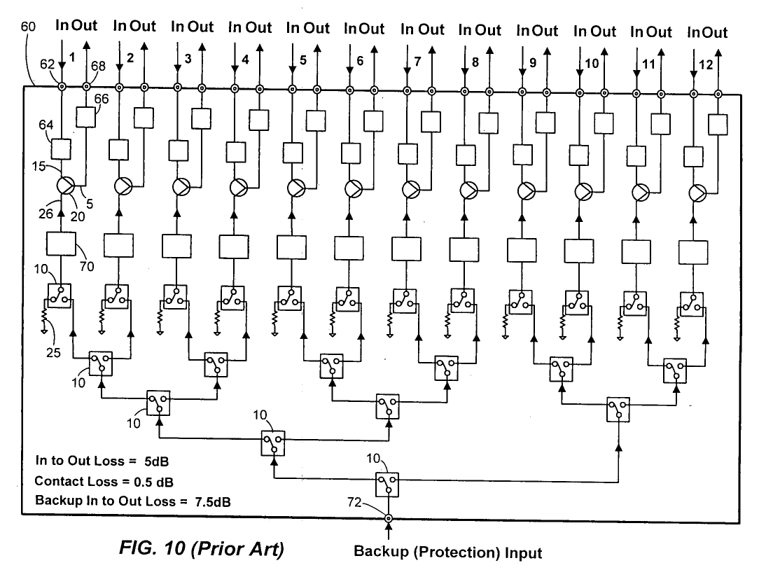

The prior art redundancy solution for Edge-QAM installations is shown in a block diagram in FIG. 10, depicting a redundancy RF switch bank 60 protecting 12 main lines with one spare backup (protection) line, referred to as “12+1 redundancy”. Each main line has a pair of ports consisting of an input port (In) and an output port (Out). The port pairs are labeled from 1 through 12. The design is intended for stand-alone chassis application, with all ports connected to chassis-installed standard F-connectors 62, 68 and 72.

The main building block of the switch bank 60 is block 20, the two-way combiner of FIG. 2, the insertion loss of which is 3.5 dB. Blocks 64, 70 and 66 represent the matching circuits at each port of the combiner 20. As discussed earlier, these matching circuits are necessary in order to achieve the required return loss specification in all ports around the combiner 20. The insertion loss of each matching block 64, 70 and 66 is about ¾ dB. The insertion loss of the main path, from input to output is 5 dB (3.5+2×0.75). As said earlier, this excessive insertion loss is the principal disadvantage and a serious impediment of the entire product.

The switch bank 60 includes a pyramid of relays which route the Backup (Protection) input into the desired output direction. One relay contact has an insertion loss of about 0.2 dB and estimating the PCB trace insertion and mismatch losses at about 0.3 dB, a total of 0.5 dB can be allocated for each contact. There are 5 layers of relay contacts in a path from Backup input to any of the 12 outputs, so the relay path loss amounts to 2.5 dB. The loss from the Backup Input to Output is therefore 2.5 dB above the In/Out loss, i.e. it is 7.5 dB. This higher loss only further aggravates the already inadequate specification achievable with this design of the prior art.

One possible way of overcoming the high insertion loss of the design of FIG. 10 would be to add an RF amplifier to make up for the loss. Brief analysis reveals that in addition to increasing the power, cost and complexity of such solution, it would probably fail to achieve the basic goal, which is to provide a redundancy solution having very high reliability and high EOS resilience. The latter is certainly not true with such a solution. Moreover, any attempt to integrate such redundancy solution in the same chassis with the QAM RF sources, in order to gain all its advantages would most likely be futile. The reason is the increased power dissipation due to added amplifiers would reduce the thermal budget, most likely limiting the otherwise achievable channel densities. Therefore, this implementation is limited to stand-alone chassis only, with its wire-intensive downside, precluding the ability to coexist in an integrated slim, competitive EQAM chassis.

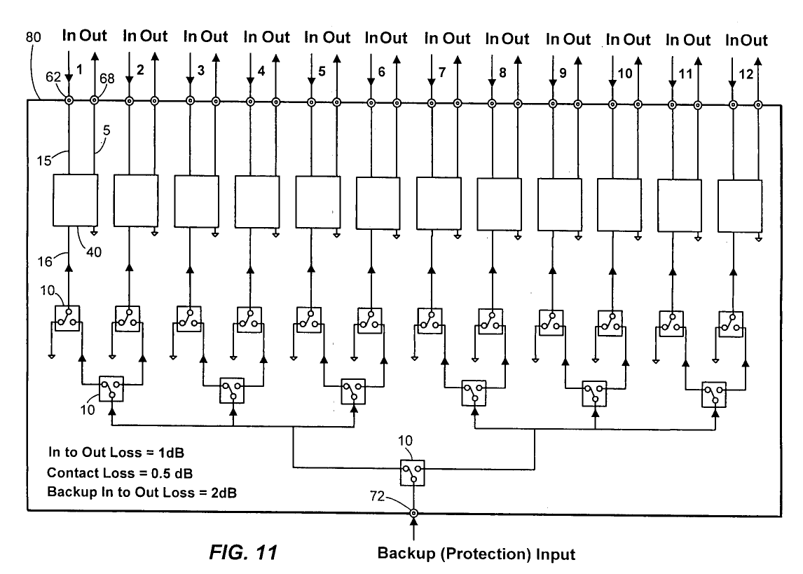

FIG. 11 is a block diagram of one embodiment of the redundancy solution of the present invention for Edge-QAM installations, showing a redundancy RF switch bank 80 protecting 12 main lines with one spare protection line (“12+1 redundancy”), designed for stand-alone chassis, with all ports connected to chassis-installed standard F-connectors 62, 68 and 72. The RF switch circuit 40 of FIG. 3 is employed as the key element. It should be understood that circuit 40 is only exemplary and that the switch configurations disclosed in other figures can be used instead. While circuit 40 is used at all 12 RF In/Out ports of the bank 80 (labeled 1 through 12), for clarity the designator 40 is shown only at the block serving the port 1. One advantage of the FIG. 11 solution is in the very low insertion loss of the main line of only 1 dB, while the backup line has 2 dB of loss. There are only three layers of switches in the protection path and they are either all relays or the combination of relays and active switches (such as RF CMOS, GaAs, SiGe IC switches, PIN diode switches, etc). A relay contact is preferred at the output switch location 10 (especially the arm shunting the main line), for the same reasons mentioned above.

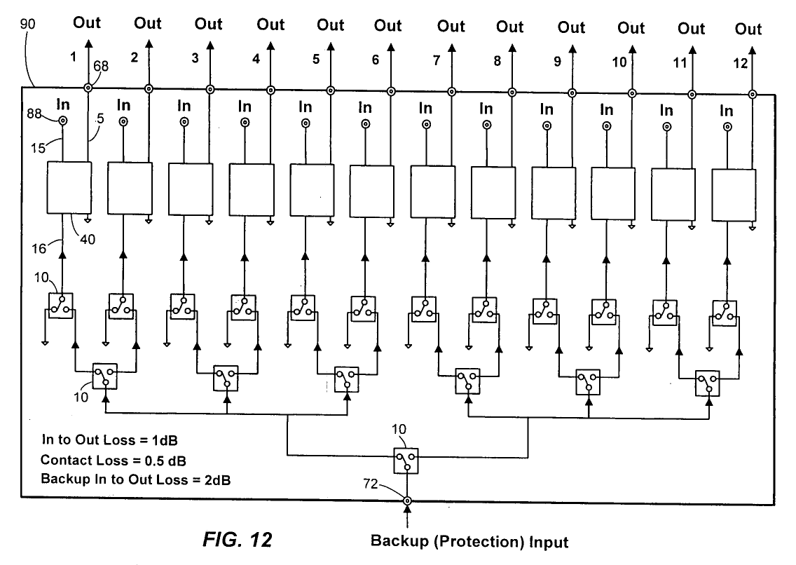

FIG. 12 is a block diagram of another embodiment of the redundancy solution of the present invention for Edge-QAM installations, showing a “12+1 redundancy” bank 90. Like in the previous case, the RF switch circuit 40 of FIG. 3 is shown as the key element, but it should be understood that circuit 40 is only exemplary and that the switch configurations disclosed in other figures can be used instead. While circuit 40 is used at all 12 RF In/Out ports of the bank 80 (labeled 1 through 12), for clarity the designator 40 is shown only at the block serving the port 1. The bank 90 is electrically identical to bank 80 of FIG. 11, but designed for internal installation into the chassis with QAM sources, as indicated by the location of the input connector 88 on the inside of the bank 90 boundary. Moreover, the connector 88 being internal to the chassis, unlike its counter part 62 in stand-alone chassis solutions described earlier, does not have to be of the type F (which is required for all inter-equipment cabling in a CATV installation). Rather, a broad range of connectors can be used, providing various benefits such as smaller size, better performance (particularly the return loss) and reliability, lower electromagnetic interference (EMI), easier and faster to mate/un-mate, to name a few. A connector type referred to as MCX has been gaining popularity lately, and for example can be a good choice. Key advantage of this design is in the reduced wire complexity of the user's installations—the external coaxial cables count is reduced by a factor of two. While the total cable count is still the same, half of the cables are internal to the chassis and are transparent to the user. In addition to simplifying the user's installation, reduced number of cables helps improve the reliability of the installation. Otherwise, the insertion loss is the same as with the external chassis (insertion loss of the main line is 1 dB, the backup line has a loss of 2 dB). The switches in the protection path may all be active (insertion loss and distortion permitting); relay may still be preferred in the main output line although PIN diode can be considered, due to its high ESD resilience. In fact, PIN diodes are used in some applications as ESD protection diodes, however they may not be capable of withstanding high surge discharges.

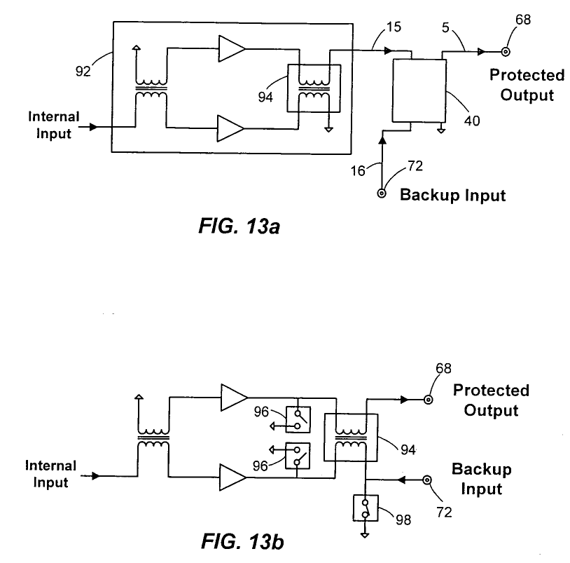

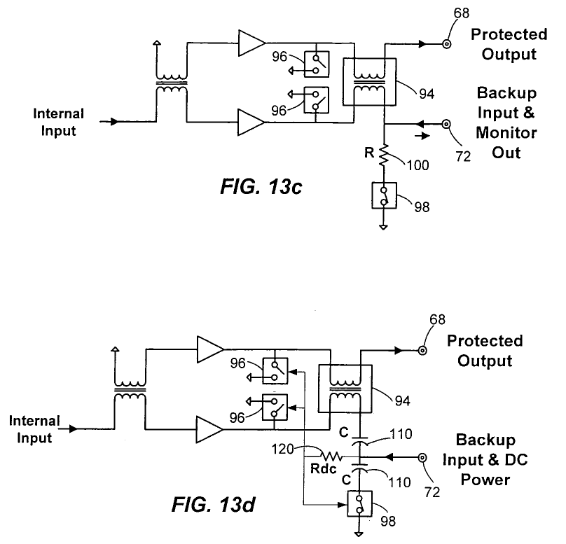

FIG. 13a is a block diagram of yet another embodiment of the redundancy solution of the present invention, this time built-in inside of an individual QAM RF Modulator (QRM). The output stage of a QRM unit, like most CATV transmitters is a well-known push-pull amplifier 92, which is interconnected directly to the main input line 15 of the present invention circuit 40, avoiding any RF cables and connectors in-between. The key advantage is in reducing the number of RF interconnects by eliminating half of the RF connector pairs, thus reducing the cost as well as improving RF performance and reliability of the entire system. One downside is that interruption of service is necessary should a replacement of QRM units be needed.

FIG. 13b is a block diagram of still another embodiment of the built-in redundancy solution of the present invention, this time embedded inside of the of the push-pull amplifier, taking advantage of its transformer 94 and using it as a part of the RF switch. This is accomplished by the means of a total of three switches, consisting of a pair of switches 96 and a switch 98, which is in a complementary state in respect to the pair 96. The switches 96 and 98 can be of any type, some of which were discussed earlier. When all switches are in the position shown in FIG. 13b, i.e. both 96 opened and 98 closed, the circuit behaves much like an ordinary push-pull amplifier 92, passing the amplified internal input signal onto the output. When the switches are flipped (both 96 closed and 98 opened), than the BACKUP from 72 input gets passed to the output 68 through the same transformer 94 and so essentially incurring no additional losses, while achieving all of the other benefits. Particularly important are the return loss performance benefits as a result of elimination of one transformer. Of course, switches with low parasitics should be used, in order not to degrade the performance of the original push-pull amplifier, particularly not to disturb the critical balance and impedance symmetry of the differential amplifier pair. If the switches are realized with relays, their de-energized state should be in the backup position (opposite than shown in the diagram). If the switches are solid-state, then their powering and control can be provided through the Backup port 72, which is shown in the next diagram. External powering and control can also be used in the case of relays. With this circuit, not only the cables and connectors are saved, but the added benefit of practically lossless redundancy switching is enjoyed. The same downside though of service interruption for repairs is here also the case.

FIG. 13c is a block diagram of a modified circuit of FIG. 13b, providing a function of monitoring the output signal in addition to the protection function by sharing the same port 72. This port outputs a small sample of the main output signal (at port 68) for monitoring purposes outside the unit, and at the same time serves as the Backup signal input port. The resistor R 100 is small, around 2 Ohms, the actual value depending on the desired coupling ratio of the main signal, which is approximately equal to 20 log (R/75) in 75 Ohm system. For example, 2 Ohms will provide about −30 dB coupling. Having a small value, the resistor R 100 shouldn't have noticeable adverse effects on the performance of the push-pull amplifier, such as on the balance, harmonic distortion, RL, etc. Of course, the monitor port works only in normal mode, when the push-pull amplifier is operational, in which case the switch 98 is closed and the backup signal muted. In the backup mode, the switch 98 is opened, and the port 72 serves as the Backup signal input. This scheme can provide a central monitoring feature in RF switch banks such as FIGS. 11 and 12 (of course, modified without blocks 40, which in this case would be absorbed in the protected unit of FIG. 13c). In this arrangement, the switches 10 in banks 80 or 90 can be sequentially switched and routed into a common monitor, probing the levels of the protected units, one by one.

FIG. 13d is a block diagram of a modified circuit of FIG. 13b, providing a function of powering and controlling the switches 96 and 98 inside the unit. Capacitors C 110 serve the purpose of DC blocking, and resistor Rdc 120 provides the biasing and control of the switches 96 and 98. The features of FIG. 13c and FIG. 13d can easily be combined in one unit, by adding a resistor R 100 in-between the switch 98 and capacitor 110.

In conclusion, it can be said that the circuits of the present invention are inherently simple and robust. In some embodiments of the invention there are no components other than the switch element and the transformer—no resistors or other components that can increase the risk of failures. Also, there are no intermediate/auxiliary-nodes in the circuits—only grounds and Inputs/Outputs. Its very low insertion loss of 0.5 dB (as a stand-alone RF switch), or 1 dB when embedded in the application along with the port isolation and its inherent surge rejection capability, combined with the above factors makes the present invention all the more attractive.

It is to be understood that the above discussion provides a detailed description of embodiments of the present invention.

The above descriptions of the embodiments will enable those skilled in the art to make many departures from the particular examples described above to provide apparatus constructed in accordance with the present invention. The embodiments are illustrative, and not intended to limit the scope of the present invention.

1. A port switching device comprising:
a coupler having a first port and second port;
a first switch connected to said first port, said first switch having an open position and a closed position, wherein when said first switch is not in a closed position, said coupler couples said first port to any other port having a switch not in the closed position; and
a second switch connected to said second port, said second switch having an open position and a closed position, wherein when said second switch is not in a closed position, said coupler couples said second port to any other port having a switch not in a closed position.

2. A port switching device comprising:
a coupler having a first port, second port and third port; and
a first switch connected to said first port, said first switch having an open position and a closed position, wherein when said first switch is not in a closed position, said coupler couples said first port to any other port having a switch not in the closed position;
a second switch connected to said second port, said second switch having an open position and a closed position, wherein when said second switch is not in a closed position, said coupler couples said second port to any other port having a switch not in a closed position; and
a third switch connected to said third port, said third switch having an open position and a closed position, wherein when said third switch is not in a closed position, said coupler couples said third port to any other port having a switch not in the closed position.

3. The device as recited in 2 further comprising:
a forth port; and
a fourth switch connected to said forth port, said forth switch having an open position and a closed position, wherein when said fourth switch is not in a closed position, said coupler couples said fourth port to any other port having a switch not in the closed position.

4. The device as recited in claim 2 wherein said coupler comprises a transformer.

5. (canceled)

6. A signal switching device comprising:
a coupling circuit having a first input and a corresponding first output, and a second input and a corresponding second output; and
a switch connected to said first input and to said second input, said switch having a first position and second position,
wherein when said switch is in said first position, said second input is grounded and said first input is connected to said first output, and
wherein when said switch is in said second position, said first input is grounded and said second input is connected to said second output.

7. The signal switching device as recited in claim 6 wherein said transformer comprises:
a first winding connecting said first input to said first output; and
a second winding connecting said second input to said second output.

8. The signal switching device as recited in claim 7 wherein said first winding and said second winding have a turn ration of 1:1.

9. The signal switching device as recited in claim 6 wherein said second output is grounded.

10-14. (canceled)
